(19) United States
(12) Patent Application Publication
(10) Pub. No.: US 2026/0254114 A1
(43) Pub. Date: Aug. 27, 2026

(54) TERAHERTZ BEAM DEFLECTOR FOR 6G BASED ON LIQUID CRYSTAL METASURFACE

(71) Applicant: LENOVO (BEIJING) LIMITED, Beijing (CN)

(72) Inventors: Daquan Yang, Beijing (CN); Erpeng Lv, Beijing (CN); Yanzhao Hou, Beijing (CN); Bingchao Liu, Beijing (CN)

(21) Appl. No.: 19/165,725

(22) PCT Filed: Mar. 17, 2023
(86) PCT No.: PCT/CN2023/082258

§ 371 Date: Sep. 16, 2025

(51) Int. Cl. H01Q 3/46; H04B 7/04

(52) U.S. Cl. CPC H01Q 3/46; H04B 7/04013

(57) ABSTRACT

Methods and apparatuses for terahertz beam deflector are disclosed. In one embodiment, a reconfigurable intelligent surface device includes a metasurface that reflects terahertz transmission with a reflection angle, wherein the reconfigurable intelligent surface device comprises a transceiver; and a processor coupled to the transceiver, wherein the processor is configured to transmit, via the transceiver, parameter for controlling the reflection angle of the metasurface; and receive, via the transceiver, an indication of a coding sequence to control the reflection angle.

### FIELD

The subject matter disclosed herein generally relates to wireless communications, and more particularly relates to apparatus and method for terahertz (THz) beam deflector for 6G based on liquid crystal metasurface.

### BACKGROUND

The sixth generation (6G) of mobile communications will use the THz band to provide ultra-high speed information transmission and ubiquitous wireless connection. Nevertheless, THz links have the disadvantages of loss of channel path and line-of-sight transmission, which greatly limits the communication transmission.

Future wireless communication systems will require new antenna technologies to meet the requirements of 6G networks. Recently, the development of electro-magnetic (EM) metasurfaces has shown promise to improve the performance of wireless networks by manipulating and radiating RF signals at reduced size, weight, power, cost, and relative complexity compared to traditional phased arrays. A THz communication system based on Reconfigurable Intelligent Surface (RIS) provides a platform for the realization of THz technology.

This invention targets improvement of RIS.

### BRIEF SUMMARY

Methods and apparatuses for terahertz beam deflector are disclosed.

In one embodiment, a RIS device includes a metasurface that reflects terahertz transmission with a reflection angle, wherein the RIS device comprises a transceiver; and a processor coupled to the transceiver, wherein the processor is configured to cause the RIS device to transmit parameter for controlling the reflection angle of the metasurface; and receive an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell. Each bit of the coding sequence may be converted by an operational amplifier to a bias voltage.

In some embodiment, the metasurface is composed of multiple meta-atoms, each meta-atom includes a liquid crystal layer sandwiched between an upper metallic layer and a lower metallic layer. In particular, a symmetrical split-ring is removed from the upper metallic layer, where an inner side of the ring connects to an outer side of the ring with two symmetrical parts of the ring that are not removed. Further particularly, the outer radius of the ring is 300 μm, the inner radius of the ring is 190 μm, and an orientation angle of each symmetrical part is 30°.

In another embodiment, a method performed at a RIS device that includes a metasurface that reflects terahertz transmission with a reflection angle comprising: transmitting parameter for controlling the reflection angle of the metasurface; and receiving an indication of a coding sequence to control the reflection angle.

In still another embodiment, a base unit comprises a transceiver; and a processor coupled to the transceiver, wherein the processor is configured to cause the base unit to: receive parameter for controlling a reflection angle of a metasurface of a RIS device, wherein, the metasurface reflects terahertz transmission with the reflection angle; and transmit an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell.

In yet another embodiment, a method performed at a base unit comprises receiving parameter for controlling a reflection angle of a metasurface of a RIS device, wherein, the metasurface reflects terahertz transmission with the reflection angle; and 804 transmitting an indication of a coding sequence to control the reflection angle.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a RIS device;

FIGS. 2(a), 2(b), 2(c) and 2(d) show an example of a structure of each LC meta-atom of the metasurface according to this disclosure;

FIGS. 3(a) and 3(b) show the distribution of liquid crystal molecules under applied voltage;

FIG. 4(a) shows the reflection amplitude of the meta-atom;

FIG. 4(b) shows the phase difference between the meta-atom in “state a” and the meta-atom in “state b”;

FIGS. 5(a)-5(d) show different implementations of unit cell;

FIG. 6 illustrates a structure of terahertz communication system;

FIG. 7 is a schematic flow chart diagram illustrating an embodiment of a method according to the present application;

FIG. 8 is a schematic flow chart diagram illustrating an embodiment of a method according to the present application; and

FIG. 9 is a schematic block diagram illustrating apparatuses according to one embodiment.

The description of elements in each Figure may refer to elements of proceeding figures. Like numbers refer to like elements in all figures, including alternate embodiments of like elements.

### DETAILED DESCRIPTION

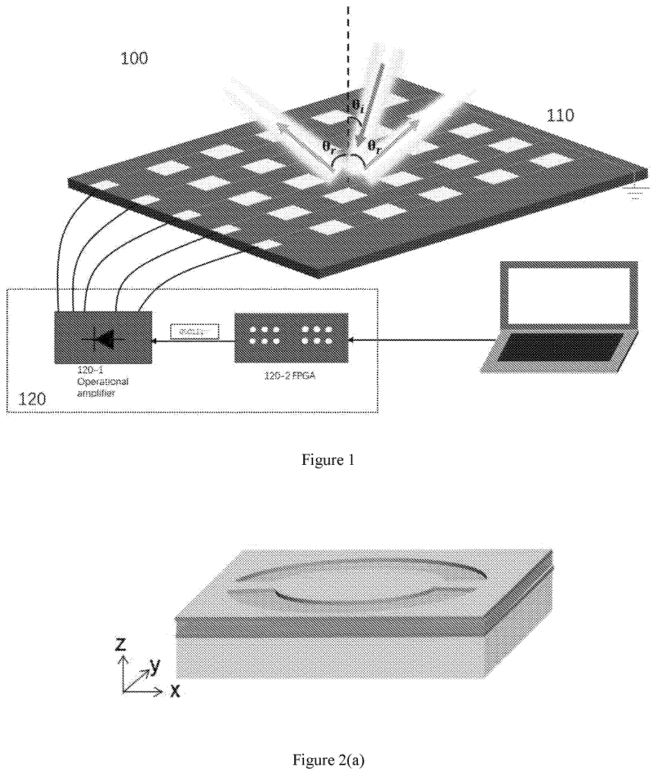

FIG. 1 illustrates a RIS device (100). The RIS device (100) is composed of an array (110) (referred to as metasurface) and an array control module (e.g., controller) (120). The array control module may include FPGA (120-2) and an operational amplifier (120-1). The metasurface includes a quantity of repeated units distributed on one or more panels, where each unit can be referred to as a meta-atom.

The RIS device may be configured to control a radiation direction of a beam (e.g., a THz beam). Snell's formula is used to explain the beam steering function. The RIS device may control a radiation direction of a beam based on Snell's formula given by Equation (1):

$$sin {θ}_{r} - sin {θ}_{i} = \frac{{λ}_{0}}{2 π {n}_{i}} \frac{d φ}{dx} \qquad ( 1 )$$

where θᵢ and θᵣ define an incident angle and a reflection angle of the THz beam, respectively; λ₀ defines an operating wavelength of the THz beam; nᵢ defines a refraction index of a medium (e.g., air) above a metasurface which is designed by a VO₂, and dφ/dx corresponds to a phase gradient endowed by the metasurface.

Various aspects of the present disclosure may determine that the refraction index (nᵢ) of air (i.e., the medium above the metasurface is air) is equal to 1 under a normal incident THz beam, where the normal incident THz beam means that the incident angle (θᵢ) is equal to 0° (i.e., sin θᵢ=0). The above Equation (1) can be simplified to Equation (2):

$$sin {θ}_{r} = \frac{{λ}_{0}}{2 π} \frac{d φ}{d x} . \qquad ( 2 )$$

As a result, the reflection angle (which indicates the radiation direction or deflection direction) (θᵣ) of the reflected THz beam may be determined according to Equation (3):

$${θ}_{r} = arcsin ( \frac{{λ}_{0}}{2 π} \frac{d φ}{d x} ) . \qquad ( 3 )$$

Therefore, the radiation direction of the reflected THz beam by the RIS device (in particular, by the metasurface) can be tuned by changing the phase gradient (dφ/dx).

In the condition of mirror reflection, the reflection angle is equal to the incident angle. Due to the property of metasurface, when the THz beam is reflected by the metasurface, a steering angle is added to the reflection angle. It means that the reflection direction is deflected or steered by the steering angle caused by the metasurface. That is, the actual reflection angle reflected by the metasurface is equal to the sum of the reflection angle and the steering angel. In this disclosure, the incident angle is equal to 0°. So, the steering angle and the actual reflection angle have the same value. In the following description, the actual reflection angle is referred to as reflection angle. In other words, in the following description, the reflection angle and the steering angle have the same value.

This disclosure proposes a RIS device used in a THz frequency (e.g., 0.213 THz), where the metasurface of the RIS device is based on liquid crystal (LC). It means that each meta-atom shown in FIG. 1 can be a LC meta-atom. The LC meta-atoms can be controlled by a controller to control the radiation direction of the reflected THz beam. For example, a field-programmable gate array (FPGA) may output a sequence, which is converted by the operational amplifier(s) to bias voltages. The bias voltages are used to control the meta-atoms to change the phase gradient (dφ/dx) of the metasurface in a THz frequency, where the THz frequency indicates an operating bandwidth of the RIS device.

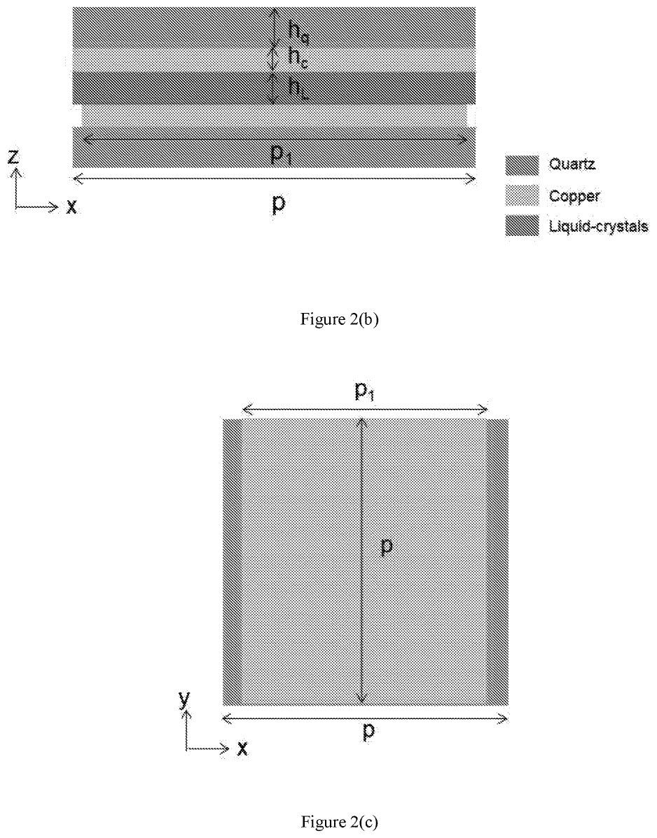

FIGS. 2(a), 2(b), 2(c) and 2(d) show an example of a structure of each LC meta-atom of the metasurface according to this disclosure. FIG. 2(a) shows a three dimensional view; FIG. 2(b) shows a front view; FIG. 2(c) shows an upper view of a lower metallic layer; and FIG. 2(d) shows an upper view of an upper metallic layer.

As shown in FIGS. 2(a) and 2(b), a LC layer is sandwiched between two metallic (e.g., copper) layers (e.g., upper metallic layer and lower metallic layer), where the LC layer is for example in a thickness (h_{L}) of 25 μm, and each metallic layer is for example in a thickness (h_{c}) of 2 μm. The metallic layers sandwiching the LC layer are sandwiched between two quartz layers (e.g., upper quartz layer and lower quartz layer, where each quartz layer is for example in a thickness (h_{q}) of 500 μm. Note that the upper quartz layer is not shown in FIG. 2(a).

FIG. 2(c) shows the upper view of the lower metallic layer on the lower quartz layer. The lower metallic layer has a length of p in y direction that is larger than p₁ which is a length in x direction. The length of p is for example 630 μm; and the length of p₁ is for example 590 μm. The two extra parts (in x direction with a total length of p−p₁) in the lower metallic layer may be filled with LC.

FIG. 2(d) shows the upper view of the upper metallic layer. The upper metallic layer occupies a square with a side length of p. As shown in FIGS. 2(a) and 2(d), a symmetrical split-ring is removed from the upper metallic layer. The outer radius (r) of the ring is for example 300 μm; and the inner radius (r₂) of the ring is for example 190 μm. The inner side of the ring connects to the outer side of the ring with two symmetrical parts of the ring (i.e., the parts that are not removed from the ring). It means that, except for the two symmetrical parts that connect the inner side of the ring to the outer side of the ring, the other two parts, that are also symmetrical, of the ring are removed. An orientation angle (α) of each symmetrical part (that connects the inner side of the ring to the outer side of the ring) refers to the angle of the symmetrical part within the ring. The orientation angle (α) is for example 30°. As can be seen from FIG. 2(d), the angular bisector of the orientation angle (α) of each symmetrical part is along the x axis. The symmetrical split-ring of the upper metallic layer forms a resonant ring structure.

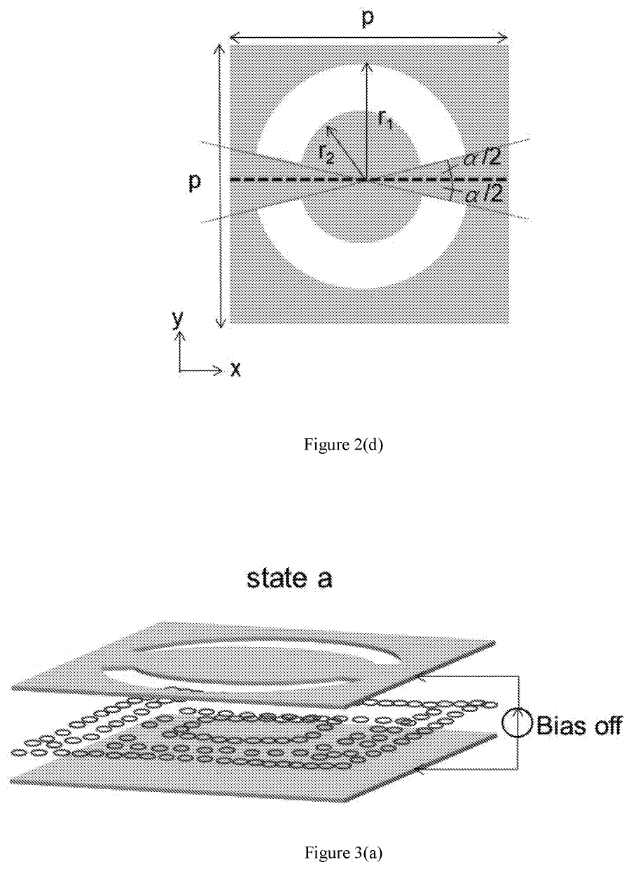

FIGS. 3(a) and 3(b) shows the distribution of LC molecules under applied voltage (e.g., bias voltage, or abbreviated as “bias”). When no voltage difference exists (i.e., bias off) between the two metallic layers, all LC molecules are aligned along the horizontal direction, which is referred to as “state a” (see FIG. 3(a)). When there is voltage difference (i.e., bias on) between the two metallic layers, due to the resonant ring structure of the upper metallic layer, only a portion of LC molecules is aligned along the electric field direction, which is referred to as “state b” (see FIG. 3(b)). In “state a”, the refractive index of the LC is referred to as extraordinary refractive index (nₑ). In “state b”, the refractive index of the LC is referred to as ordinary refractive index (nₒ). So, the refractive index of the LC is different in “state a” or “state b”, i.e., when different bias voltage is applied.

A simulation is performed on the meta-atom having the structure as described with reference to FIGS. 2(a) to 2(d). In the simulation, the LC with model LC NC-M-LC-LDn03 is used. At THz frequencies (e.g., 0.213 THz), the measurement result indicates that the refractive index of the LC is: nₑ=1.513 and nₒ=1.656.

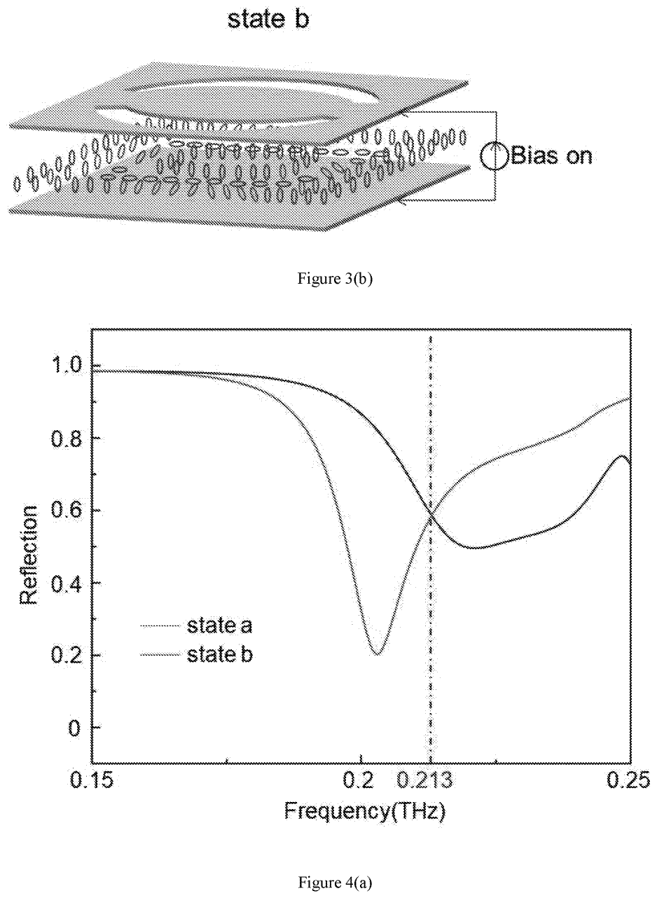

FIG. 4(a) shows the reflection amplitude of the meta-atom. It shows that the reflection coefficient at the frequency of 213 GHz (i.e., 0.213 THz) is almost the same for the meta-atom in “state a” (i.e., no voltage difference exists (i.e., bias off) between the two metallic layers) and the meta-atom in “state b” (i.e., there is voltage difference (i.e., bias on) between the two metallic layers).

FIG. 4(b) shows that, at the frequency of 213 GHZ (i.e., 0.213 THz), the phase difference (i.e., Δ phase) between the meta-atom in “state a” and the meta-atom in “state b” is about 180° (i.e., near π).

When some of the meta-atoms of a metasurface are controlled to be in “state a” and the other meta-atoms of the metasurface are controlled to be in “state b”, a phase gradient is endowed by the metasurface. Different combinations of some meta-atoms in “state a” and other meta-atoms in “state b” lead to different phase gradients, which would cause different radiation directions (or deflection directions) of the THz beam reflected by the metasurface. It means that, by configuring the state of each meta-atom of the metasurface (or by configuring the phase gradient of the metasurface), it is possible to change the radiation direction of the THz beam reflected by the metasurface. In other words, the radiation direction of the THz beam can be changed without changing the structure of the metasurface.

The following description focuses on dynamically controlling the phase gradient of the metasurface (i.e., dynamically controlling the state of each meta-atom of the metasurface), so that the radiation direction the THz beam reflected by the metasurface (which can be referred to as beam steering) can be controlled accordingly.

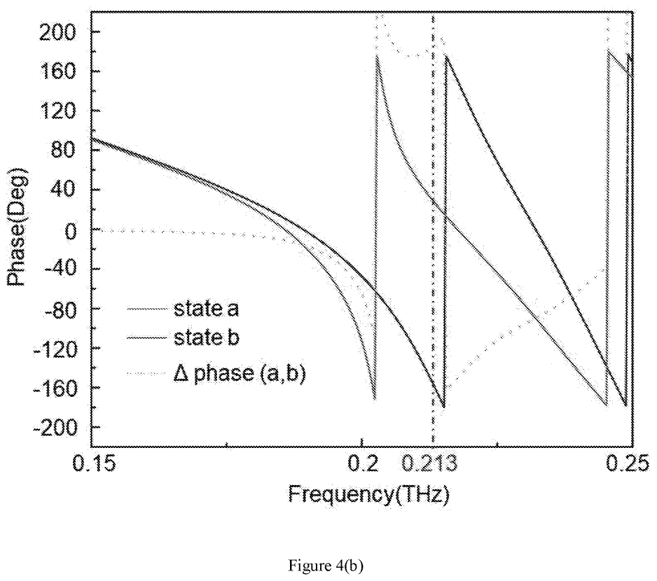

Each of FIGS. 5(a), 5(b), 5(c) and 5(d) show a schematic diagram of a metasurface including an array of LC meta-atoms, where the array contains M (M>=1) rows and N (N>=1) columns. In order to control the beam steering, the state of each meta-atom of the metasurface is controlled. As described above, the state of each meta-atom can be either “state a” or “state b”.

The meta-atom in “state a” or “state b” depends on the bias voltage applied to the upper metallic layer and the lower metallic layer. When no bias voltage exists between the upper metallic layer and the lower metallic layer of a meta-atom, the meta-atom is in “state a”; and when there is bias voltage between the upper metallic layer and the lower metallic layer of a meta-atom, the meta-atom is in “state b”.

This disclosure proposes to use 1 bit to indicate whether bias voltage is applied to a meta-atom (in particular, applied to the upper metallic layer and the lower metallic layer of the meta-atom). For example, ‘0’ indicates that bias voltage is not applied to a meta-atom (or 0V is applied), i.e., the meta-atom is in “state a”. On the other hand, ‘1’ indicates bias voltage (e.g., 20V) is applied to a meta-atom, i.e., the meta-atom is in “state b”.

In a first implementation, each of the M×N meta-atoms is controlled independently. It means that each meta-atom is a unit cell (see FIG. 5(a)). The first implementation makes the phase distribution very complex while achieving beam deflection with largest degree of freedom.

In a second implementation, all M×N meta-atoms are divided into several unit cells, where each unit cell is composed of g×h meta-atoms. It means that the M×N meta-atoms are divided into M/g×N/h unit cells (it is assumed that M=m×g, m>=1 and g>=1; and N=n×h, n>=1 and h>=1, so, M/g×N/h=mXn), where each unit cell is composed of g×h meta-atoms (see FIG. 5(b)). The g×h meta-atoms in one unit cell are controlled together, which means that all g×h meta-atoms in one unit cell are in “state a” or all g×h meta-atoms in one unit cell are in “state b”. The second implementation has fewer degrees of freedom for the beam deflection compared with the first implementation.

In a third implementation, each column of M meta-atoms in N columns is a unit cell (see FIG. 5(c)). The third implementation can be regarded as a specific second implementation in which g=M and h=1. The M meta-atoms in one unit cell (i.e., in one column) are controlled together, which means that all M×1 meta-atoms in one unit cell (i.e., in one column) are in “state a” or all M×1 meta-atoms in one column are in “state b”.

In a fourth implementation, each row of N meta-atoms in M rows can be a unit cell (see FIG. 5(d)). The fourth implementation is also a specific second implementation in which g=1 and h=N. The N meta-atoms in one unit cell (i.e., in one row) are controlled together, which means that all/XN meta-atoms in one unit cell (i.e., in one row) are in “state a” or all/X N meta-atoms in one row are in “state b”.

The third or the fourth implementation has fewer degrees of freedom for the beam deflection compared with the first implementation. On the other hand, the meta-atoms can be controlled in one dimension (per column or per row), which is simple for controlling.

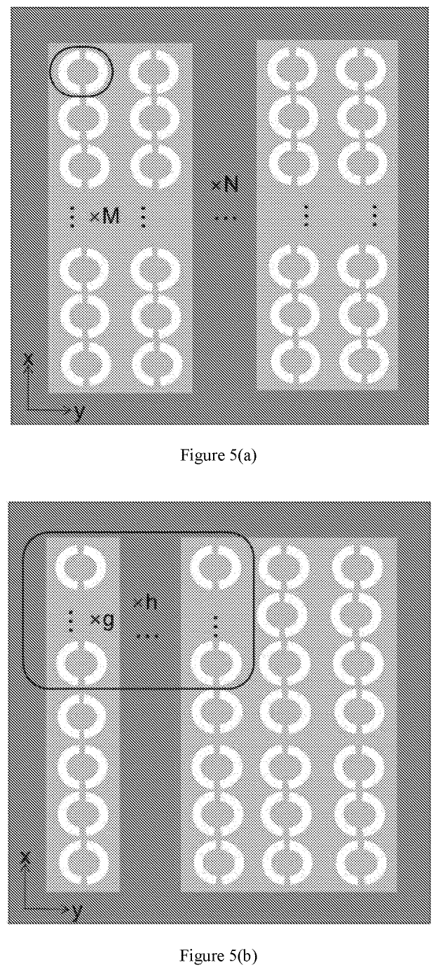

FIG. 6 illustrates a structure of THz communication system 600. As shown in FIG. 6, the RIS device (620) (in particular, the metasurface) reflects the beam received from the base unit (610) (e.g., gNB) to the UE (630). The RIS device (620) includes a RIS controller (625) which functions as the processor and the FPGA. The THz beam control is realized by controlling the phase gradient of the meta-atoms of the metasurface (i.e., controlling the state of each meta-atom of the metasurface). For example, a coding sequence (e.g., a coding sequence ID indicating a coding sequence) is indicated from the gNB (610) to the RIS controller (625). The coding sequence corresponding to the indicated coding sequence ID is generated by the FPGA to apply to the metasurface. That is, each bit of the coding sequence, which is ‘0’ or ‘1’, is applied to one unit cell. In particular, ‘0’ is converted to “Bias off” (i.e., no voltage bias, e.g., 0V) to apply to all meta-atoms in the unit cell; and ‘1’ is converted to “Bias on” (i.e., a voltage bias, e.g., 20V) to apply to all meta-atoms in the unit cell.

To help the gNB (610) generate or indicate an appropriate coding sequence, the RIS device (620) shall report its array structure and the corresponding parameters to the gNB (610). In particular, considering that the metasurface is composed of M×N meta-atoms and each unit cell is composed of g×h meta-atoms, the values of M, N, g and h shall be reported. It is assumed that the g×h meta-atoms in one unit cell are controlled together, i.e., they are controlled in the same state (“state a” or “state b”).

Based on the values of M, N, g and h, the gNB may generate and send a coding sequence to the RIS device.

For example, if M=18, N=16, g=18, h=1 are reported from the RIS device to the gNB, the gNB knows that the metasurface is composed of 18×16 meta-atoms, and each column of 18 meta-atoms are controlled together. The gNB may generate a coding sequence with 16 (=M/g×N/h) bits to apply to the metasurface. When a coding sequence is received by the RIS device (e.g., by RIS controller) from the gNB, the RIS controller (e.g., the FPGA) inputs the coding sequence to the operational amplifier (see FIG. 1). The operational amplifier outputs the bias voltages (e.g., 0V corresponding to ‘0’ or 20V corresponding to ‘1’) to the unit cells (i.e., columns) of meta-atoms of the metasurface. For example, if a coding sequence ‘0101010101010101’ is received, the bias voltage of meta-atoms to be applied to each column (from column #1 to column #16) of meta-atoms of the metasurface is shown in Table 1.

TABLE 1

| Sequence | 0 | 1 | 0 | 1 | 0 | 1 | 0 | 1 | 0 | 1 | 0 | 1 | 0 | 1 | 0 | 1 |
|---|---|---|---|---|---|---|---|---|---|---|---|---|---|---|---|---|
| Column | 1 | 2 | 3 | 4 | 5 | 6 | 7 | 8 | 9 | 10 | 11 | 12 | 13 | 14 | 15 | 16 |
| Bias | 0 | 20 | 0 | 20 | 0 | 20 | 0 | 20 | 0 | 20 | 0 | 20 | 0 | 20 | 0 | 20 |
| voltage | | | | | | | | | | | | | | | | |
| (V) | | | | | | | | | | | | | | | | |

Incidentally, when the values of M, N, g and h are reported, if g=1 and h=1, the first implementation is assumed; if g=M and h=1, the third implementation is assumed; and if g=1 and h=N, the variety of the third implementation is assumed.

Instead of reporting the values of M, N, g and h, the RIS device may report a mapping relation between a coding sequence (or a coding sequence index) and a beam direction.

Traditionally, a beam direction (e.g., reflection angle) can be controlled by a set of downtilt angle (θ) and azimuth angle (φ), i.e., (θ, φ). It means that the beam direction includes downtilt angle (θ) and azimuth angle (φ) in two dimensions. When the reflected beam by the metasurface can only be steered in a single dimension, only one of downtilt angle (θ) and azimuth angle (φ) can be steered by the metasurface. To help the gNB sending a correct coding sequence to generate a desired reflection angle, each coding sequence can be associated with a beam direction (θ, φ) or at least one of downtilt angle (θ) and azimuth angle (φ). For example, a mapping between coding sequence (and/or coding sequence index) and beam direction can be established as in Table 2.

TABLE 2

| Coding sequence index | Coding sequence | Reflect beam direction |
|---|---|---|
| 0 | ν₀ | (θ₀, φ₀) |
| 1 | ν₁ | (θ₁, φ₁) |

. . .

| | | |
|---|---|---|
| K − 1 | ν_{K-1} | (θ_{K-1}, φ_{K-1}) |

A coding sequence corresponds to a reflection angle (or a steering angle), which means the radiation direction (or deflection direction) by the metasurface. The RIS device may report to gNB the mapping relation between an index (e.g., coding sequence index) and deflection direction as shown in Table 3.

TABLE 3

| Coding sequence index | deflection direction |
|---|---|
| 0 | (θ₀, φ₀) |
| 1 | (θ₁, φ₁) |

. . .

| | |
|---|---|
| K − 1 | (θ_{K-1}, φ_{K-1}) |

Based on the mapping relation between coding sequence index and deflection direction as shown in Table 3, the gNB may determine a desired coding sequence (by its coding sequence index) based on the desired deflection direction. The FPGA may store all coding sequences corresponding to all the supported deflection directions. When a coding sequence index is received, the FPGA may generate a coding sequence corresponding to the coding sequence index and input the coding sequence to the operational amplifier which generates bias voltages to each unit cell of the metasurface.

From the view point of gNB, the gNB does not need to know that the index indicating the deflection direction is an index of the coding sequence. It means that gNB is only necessary to know that an index indicates a deflection direction. In other words, the gNB may regard Table 3 as Table 4.

TABLE 4

| index | deflection direction |
|---|---|
| 0 | (θ₀, φ₀) |
| 1 | (θ₁, φ₁) |

. . .

| | |
|---|---|
| K − 1 | (θ_{K-1}, φ_{K-1}) |

When a desired deflection direction (e.g., (θ₁, φ₁)) is needed, the gNB determines an index (e.g., 1) from Table 4, and indicates the index (e.g., 1) corresponding to the desired deflection direction to the RIS device.

As a whole, the deflection direction by the metasurface can be controlled by the coding sequence. That is, the structure of the metasurface (or the structure of each meta-atom of the metasurface) does not need to be changed when the deflection direction by the metasurface is changed according to the coding sequence. In other words, the metasurface (or the RIS), in particular, the deflection direction by the metasurface (or the RIS device), is reconfigurable.

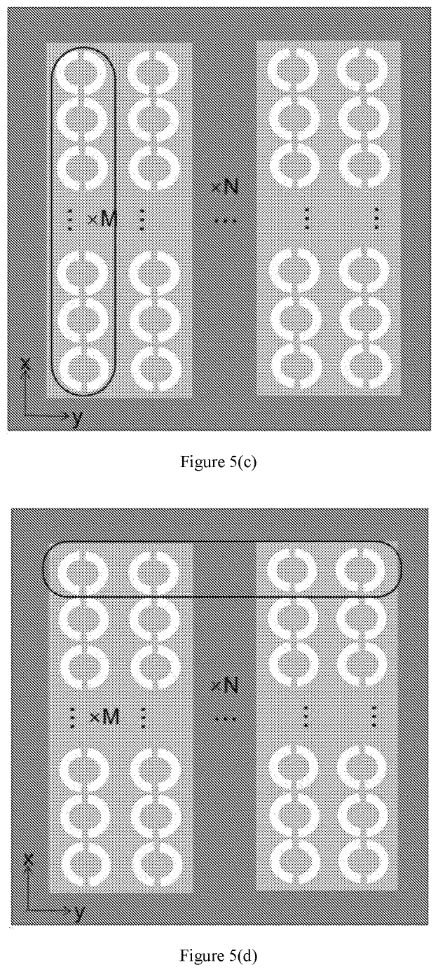

FIG. 7 is a schematic flow chart diagram illustrating an embodiment of a method 700 according to the present application. In some embodiments, the method 700 is performed by an apparatus, such as a RIS device, wherein the RIS device includes a metasurface that reflects THz transmission with a reflection angle. In certain embodiments, the method 700 may be performed by a processor executing program code, for example, a microcontroller, a microprocessor, a CPU, a GPU, an auxiliary processing unit, a FPGA, or the like.

The method 700 may comprise 702 transmitting parameter for controlling the reflection angle of the metasurface; and 704 receiving an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell. Each bit of the coding sequence may be converted by an operational amplifier to a bias voltage.

In some embodiment, the metasurface is composed of multiple meta-atoms, each meta-atom includes a liquid crystal layer sandwiched between an upper metallic layer and a lower metallic layer. In particular, a symmetrical split-ring is removed from the upper metallic layer, where an inner side of the ring connects to an outer side of the ring with two symmetrical parts of the ring that are not removed. Further particularly, the outer radius of the ring is 300 μm, the inner radius of the ring is 190 μm, and an orientation angle of each symmetrical part is 30°.

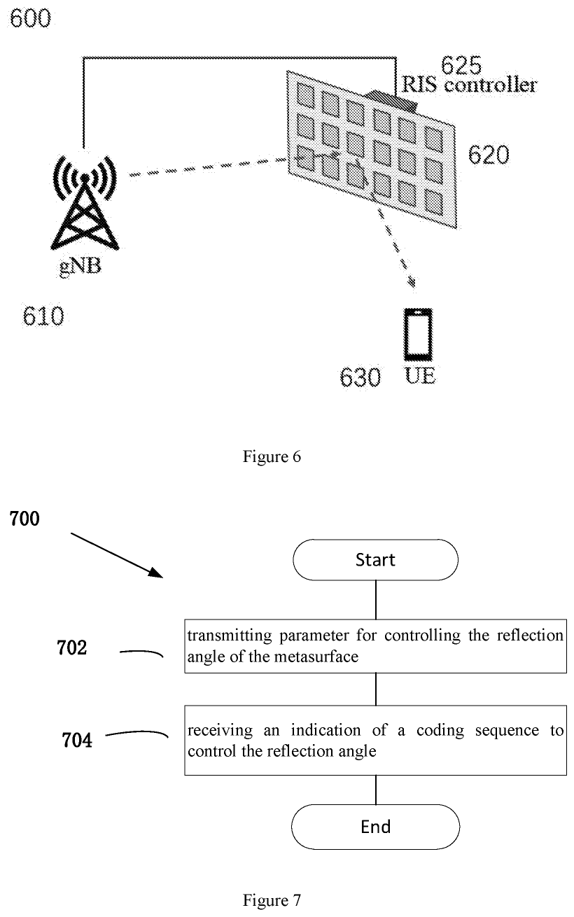

FIG. 8 is a schematic flow chart diagram illustrating an embodiment of a method 800 according to the present application. In some embodiments, the method 800 is performed by an apparatus, such as a base unit. In certain embodiments, the method 800 may be performed by a processor executing program code, for example, a microcontroller, a microprocessor, a CPU, a GPU, an auxiliary processing unit, a FPGA, or the like.

The method 800 may comprise 802 receiving parameter for controlling a reflection angle of a metasurface of a RIS device, wherein, the metasurface reflects terahertz transmission with the reflection angle; and 804 transmitting an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell.

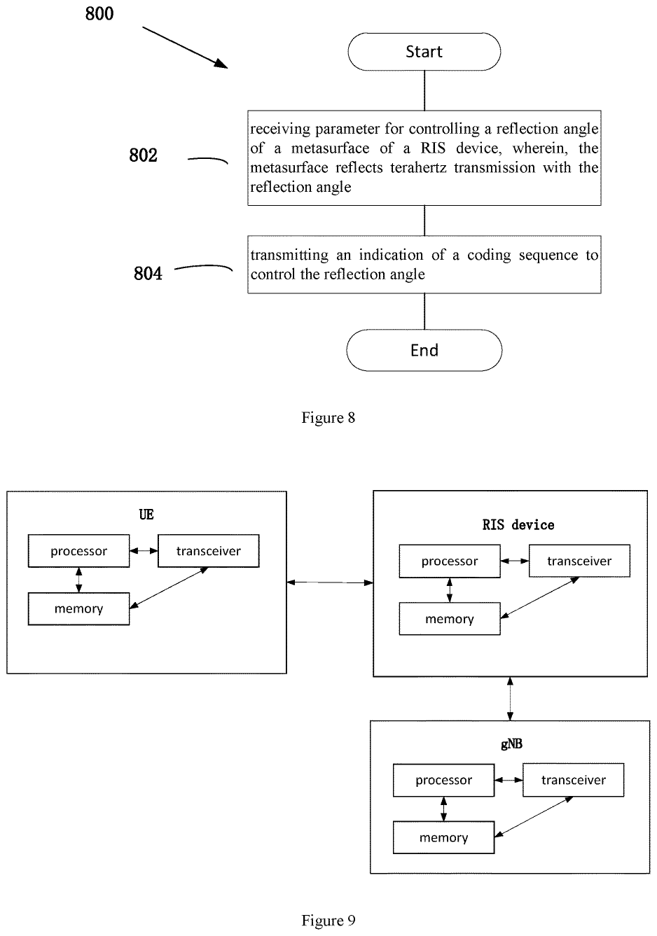

FIG. 9 is a schematic block diagram illustrating apparatuses according to one embodiment.

Referring to FIG. 9, the RIS device includes a processor, a memory, and a transceiver that is a transmitter and/or a receiver. The processors implement a function, a process, and/or a method which are proposed in FIG. 7.

A RIS device includes a metasurface that reflects terahertz transmission with a reflection angle, wherein the RIS device comprises a transceiver; and a processor coupled to the transceiver, wherein the processor is configured to cause the RIS device to transmit parameter for controlling the reflection angle of the metasurface; and receive an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell. Each bit of the coding sequence may be converted by an operational amplifier to a bias voltage.

In some embodiment, the metasurface is composed of multiple meta-atoms, each meta-atom includes a liquid crystal layer sandwiched between an upper metallic layer and a lower metallic layer. In particular, a symmetrical split-ring is removed from the upper metallic layer, where an inner side of the ring connects to an outer side of the ring with two symmetrical parts of the ring that are not removed. Further particularly, the outer radius of the ring is 300 μm, the inner radius of the ring is 190 μm, and an orientation angle of each symmetrical part is 30°.

The gNB (i.e., the base unit) includes a processor, a memory, and a transceiver that is a transmitter and/or a receiver. The processors implement a function, a process, and/or a method which are proposed in FIG. 8.

The base unit comprises a transceiver; and a processor coupled to the transceiver, wherein the processor is configured to cause the base unit to: receiveparameter for controlling a reflection angle of a metasurface of a RIS device, wherein, the metasurface reflects terahertz transmission with the reflection angle; and transmit an indication of a coding sequence to control the reflection angle.

In some embodiment, the parameter for controlling the reflection angle of the metasurface is a mapping relation between an index and the reflection angle, and the indication of the coding sequence is the index.

In some embodiment, the metasurface is composed of M×N meta-atoms, where M>=1 and N>=1, each unit cell is composed of g×h meta-atoms, where m>=1 and g>=1, the parameter for controlling the reflection angle of the metasurface is the values of M, N, g and h, and the indication of the reflection angle is a coding sequence with M/g×N/h bits. Each bit in the coding sequence may control the states of all meta-atoms in one unit cell. Each bit of the coding sequence may be set as ‘0’ or ‘1’ corresponding to a different state of the meta-atoms in one unit cell.

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A reconfigurable intelligent surface device comprising:
a transceiver; and
a processor coupled to the transceiver, wherein the processor is configured to cause the reconfigurable intelligent surface device to:
transmit a parameter for controlling a reflection angle of a metasurface that reflects terahertz transmissions with the reflection angle; and
receive an indication of a coding sequence to control the reflection angle.

2. The reconfigurable intelligent surface device of claim 1, wherein, the parameter for controlling the reflection angle of the metasurface comprises a mapping relation between an index and the reflection angle, and the indication of the coding sequence comprises the index.

3. The reconfigurable intelligent surface device of claim 1, wherein, the metasurface comprises M×N meta-atoms, where M>=1 and N>=1, each unit cell is composed of g×h meta-atoms, where m>=1 and g>=1, the parameter for controlling the reflection angle of the metasurface comprises the values of M, N, g, and h, and the indication of the reflection angle comprises a coding sequence with M/g×N/h bits.

4. The reconfigurable intelligent surface device of claim 3, wherein, each bit in the coding sequence controls the states of al meta-atoms in one unit cell.

5. The reconfigurable intelligent surface device of claim 4, wherein, each bit of the coding sequence is set as ‘0’ or ‘1’ corresponding to a different state of the meta-atoms in one unit cell.

6. The reconfigurable intelligent surface device of claim 4, wherein, each bit of the coding sequence is converted by an operational amplifier to a bias voltage.

7. The reconfigurable intelligent surface device of claim 1, wherein, the metasurface comprises multiple meta-atoms, and each meta-atom includes a liquid crystal layer sandwiched between an upper metallic layer and a lower metallic layer.

8. The reconfigurable intelligent surface device of claim 7, wherein, a symmetrical split-ring is removed from the upper metallic layer, where an inner side of the ring connects to an outer side of the ring with two symmetrical parts of the ring that are not removed.

9. The reconfigurable intelligent surface device of claim 8, wherein, the outer radius of the ring is 300 um, the inner radius of the ring is 190 um, and an orientation angle of each symmetrical part is 30°.

10. A base unit, comprising:
a transceiver; and
a processor coupled to the transceiver, wherein the processor is configured to cause the base unit to:
receive a parameter for controlling a reflection angle of a metasurface of a reconfigurable intelligent surface device, wherein, the metasurface reflects terahertz transmissions with the reflection angle; and
transmit an indication of a coding sequence to control the reflection angle.

11. The base unit of claim 10, wherein, the parameter for controlling the reflection angle of the metasurface comprises a mapping relation between an index and the reflection angle, and the indication of the coding sequence comprises the index.

12. The base unit of claim 10, wherein, the metasurface comprises M×N meta-atoms, where M>=1 and N>=1, each unit cell comprises g×h meta-atoms, where m>=1 and g>=1, the parameter for controlling the reflection angle of the metasurface is the values of M, N, g, and h, and the indication of the reflection angle comprises a coding sequence with M/g×N/h bits.

13. The base unit of claim 12, wherein, each bit in the coding sequence controls the states of all meta-atoms in one unit cell.

14. The base unit of claim 13, wherein, each bit of the coding sequence is set as ‘0’ or ‘1’ corresponding to a different state of the meta-atoms in one unit cell.

15. A method comprising:
transmitting a parameter for controlling a reflection angle of a metasurface that reflects terahertz transmissions with the reflection angle; and
receiving an indication of a coding sequence to control the reflection angle.

16. The method of claim 15, wherein the metasurface comprises M×N meta-atoms, where M>=1 and N>=1, each unit cell is composed of g×h meta-atoms, where m>=1 and g>=1, the parameter for controlling the reflection angle of the metasurface comprises the values of M, N, g, and h, and the indication of the reflection angle comprises a coding sequence with M/g×N/h bits.

17. A user equipment (UE) comprising:
at least one memory; and
at least one processor coupled with the at least one memory and configured to cause the UE to:
receive a parameter for controlling a reflection angle of a metasurface that reflects terahertz transmissions with the reflection angle; and
transmit an indication of a coding sequence to control the reflection angle.

18. The user equipment of claim 17, wherein the parameter for controlling the reflection angle of the metasurface comprises a mapping relation between an index and the reflection angle, and the indication of the coding sequence comprises the index.

19. The user equipment of claim 17, wherein the metasurface comprises M×N meta-atoms, where M>=1 and N>=1, each unit cell is composed of g×h meta-atoms, where m>=1 and g>=1, the parameter for controlling the reflection angle of the metasurface comprises the values of M, N, g, and h, and the indication of the reflection angle comprises a coding sequence with M/g×N/h bits.

20. The user equipment of claim 19, wherein each bit in the coding sequence controls the states of al meta-atoms in one unit cell, each bit of the coding sequence is set as ‘0’ or ‘1’ corresponding to a different state of the meta-atoms in one unit cell, and each bit of the coding sequence is converted by an operational amplifier to a bias voltage.
